(19) United States
(12) Patent Application Publication
(10) Pub. No.: US 2011/0064424 A1
(43) Pub. Date: Mar. 17, 2011

(54) DYNAMIC MEDIA THICKNESS, CURL SENSING SYSTEM

(75) Inventors: Peter Knausdorf, Henrietta, NY (US); Ruddy Castillo, Briarwood, NY (US)

(73) Assignee: XEROX CORPORATION, NORWALK, CT (US)

(21) Appl. No.: 12/560,006

(22) Filed: Sep. 15, 2009

(51) Int. Cl. G03G 15/00

(52) U.S. Cl. 399/16; 399/406

(57) ABSTRACT

A method and system move a media sheet in a processing direction of a media path from a first nip to a second nip and move the media sheet in the processing direction of the media path from the second nip to a third nip. The method senses, using a sensor positioned between the second nip and the third nip, the position of the media sheet relative to the sensor. The method automatically calculates the amount of curl the media sheet contains based on the difference between the predetermined position and the position of the leading edge of the media sheet (relative to the sensor) as the leading edge of the media sheet passes between the second nip and the third nip, using the processor. Further, the method automatically calculates the thickness of the media sheet based on the difference between the predetermined position and the position of the media sheet (relative to the sensor) as the media sheet passes between the second nip and the third nip, using the processor.

### BACKGROUND AND SUMMARY

Embodiments herein generally relate to printing methods and devices and more particularly relate to systems that accommodate media curling and different media thicknesses.

Printing systems such as electro-photographic, inkjet, and ultra-violet (UV) curable systems, have higher quality results if the thickness and curl of the media being used is known and adjusted for. Current systems rely on users to input the type of paper being used via the “user interface”. This approach only tells the printing apparatus the approximate weight of the paper and not its actual thickness and is subject to wrong input. Conventional decurling adjustments are also based on a combination of user inputs and some sensor data such as temperature, humidity, double sided printing mode, etc. Current systems do not measure actual curl, but estimate what the curl is likely to be based on setup parameters. In addition to an apparatus automatically picking a decurler setting or curler setting, some machines provide an additional manual adjustment that usually cannot be made on the fly. Complicating the problem for these systems is the uncertain nature of paper in its curl behavior.

For example, U.S. Pat. No. 5,519,481 (incorporated herein by reference) describes an adaptive decurler for selective decurling localized image areas, where a segmented decurling device forms a drive nip with an elastically deformable surfaced roll. A plurality of sensors are provided to determine the basis weight of the copy sheet, the density of the image being transferred to the copy sheet and fused thereon, the relative humidity of the machine environment, the process speed of the print engine, and any other relevant parameters. Signals indicative of these parameters are generated and sent to the machine controller which processes these signals to determine the degree of curl expected in a sheet. Based on the degree of curl for each sheet section corresponding to a decurler segment, the decurler segment is actuated to a setting which should provide the proper amount of mechanical decurling force. Each segment is activated only for the duration deemed necessary to decurl the imaged sheet portion corresponding thereto.

While conventional systems estimate sheet curl, the present embodiments comprise a method and a system of rollers, sensors, and processors used to determine actual paper curl and paper thickness. Once the actual paper curl and thickness is determined, such information is used for adjusting printing parameters. The system uses rollers to hold the paper precisely at a fixed distance while a displacement sensor measures edge curl followed by paper thickness. The resulting data is then processed to predict the overall curl of the paper. The system uses the thickness data to more accurately determine curl based on methodologies and/or look up tables. Also, the setup can involve a calibration mode to accurately measure paper thickness.

More specifically, embodiments herein provide an apparatus that has a media path that transports a media sheet; a first nip (comprising opposing rollers) that moves the media sheet in a processing direction; a second nip (also comprising opposing rollers) that is positioned within the media path to receive the media sheet from the first nip; and a third nip (again comprising opposing rollers) that is positioned within the media path to receive the media sheet from the second nip. A sensor is positioned between the second nip and the third nip. The sensor senses the position of the media sheet relative to the sensor.

A processor that is operatively connected to the sensor automatically calculates the amount of curl (up or down) the media sheet contains based on the difference between a predetermined position (determined using a calibration sheet) and the position of the leading edge of the media sheet (relative to the sensor) as the leading edge of the media sheet passes between the second nip and the third nip.

In addition, the processor can automatically calculate the thickness of the media sheet based on the difference between the predetermined position and the position of the media sheet (relative to the sensor) as the media sheet passes between the second nip and the third nip.

The opposing rollers within the first nip, the second nip, and the third nip each comprise a fixed-position roller and a floating roller. The floating roller is positioned to contact a first side (the top side) of the media sheet and the sensor is also positioned to sense the first side of the media sheet. The opposing rollers of the second nip rotate faster than the opposing rollers of the first nip, and the opposing rollers of the third nip rotate faster than the opposing rollers of the second nip to keep the media sheet taunt during the curl and thickness measurements.

The apparatus can also include a decurler positioned within the media path. The processor automatically alters settings of the decurler based on the actual amount of curl the media sheet contains. Further, the apparatus can contain a marking engine positioned within the media path. Again, the processor automatically alters settings of the marking engine based on the amount of curl the media sheet contains and the thickness of the media sheet. The marking engine can comprise any type of marking engine, such as an electro-photographic printing engine, an inkjet printing engine, an ultra-violet curable printing engine, etc.

Method embodiments are also described below. In such embodiments, the method moves the media sheet in the processing direction of the media path from the first nip to the second nip and moves the media sheet in the processing direction of the media path from the second nip to the third nip. The method senses, using the sensor positioned between the second nip and the third nip, the position of the media sheet relative to the sensor. The method automatically calculates the amount of curl the media sheet contains based on the difference between the predetermined position and the position of the leading edge of the media sheet (relative to the sensor) as the leading edge of the media sheet passes between the second nip and the third nip, using the processor. Further, the method automatically calculates the thickness of the media sheet based on the difference between the predetermined position and the position of the media sheet (relative to the sensor) as the media sheet passes between the second nip and the third nip, using the processor.

The method can also automatically alter the settings of the decurler positioned within the media path based on the amount of the curl the media sheet contains using the processor. Also, the method can automatically alter settings of the marking engine positioned within the media path based on the amount of curl the media sheet contains and the thickness of the media sheet using the processor.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a side-view schematic diagram of a device according to embodiments herein;

FIG. 2 is a side-view schematic diagram of a device according to embodiments herein;

FIG. 3 is a schematic diagram illustrating hanging curl measurement;

FIG. 4 is a chart illustrating the relationship between displacement and curl radius according to embodiments herein;

FIG. 5 is a side-view schematic diagram of a device according to embodiments herein; and

FIG. 6 is a flowchart illustrating method embodiments herein.

### DETAILED DESCRIPTION

As mentioned above, current systems rely on users to input the type of paper being used via the “user interface”. Conventional decurling adjustments are also based on a combination of user inputs and some sensor data such as temperature, humidity, double sided printing mode, etc. Current systems do not measure actual curl, but estimate what the curl is likely to be based on such setup parameters.

Therefore, the embodiments herein provide a media thickness curl sensing system that comprises a series of three nips used to control a sheet of paper in a precise way so that the curl and thickness attributes can be measured. At the heart of the system is a displacement sensor that is used to measure fly height and paper thickness.

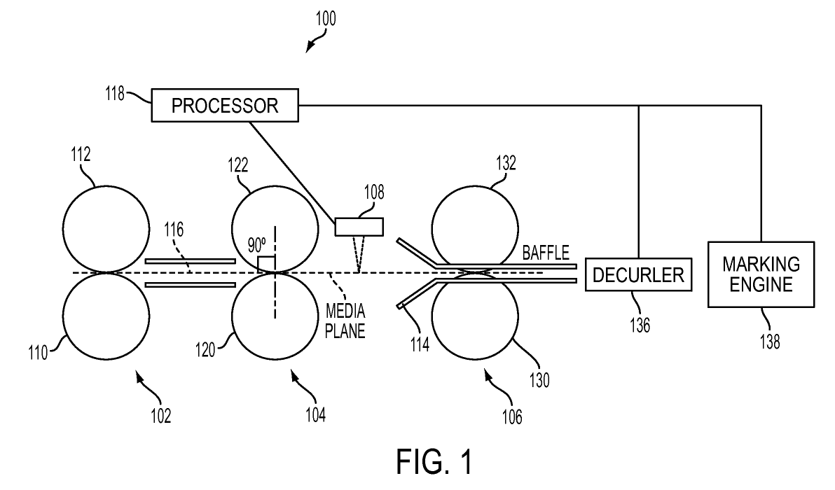

More specifically, as shown in FIG. 1, one apparatus according to embodiments herein has a media path 116 that transports a media sheet 124; a first nip 102 (comprising opposing rollers 110, 112) that moves the media sheet 124 in a processing direction; a second nip 104 (also comprising opposing rollers 120, 122) that is positioned within the media path 116 to receive the media sheet 124 from the first nip 102; and a third nip 130 (again comprising opposing rollers) that is positioned within the media path 116 to receive the media sheet 124 from the second nip 104. A sensor 108 is positioned between the second nip 104 and the third nip 130. The sensor can be any type of readily available sensor, such as one that is light based (laser), sound based (sonar), air pressure based, etc. The sensor 108 senses the position of the media sheet 124 relative to the sensor 108.

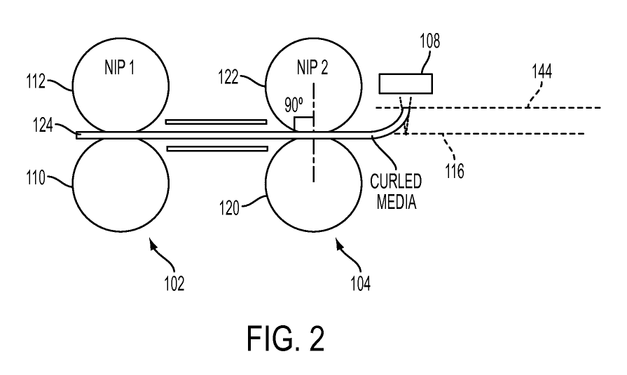

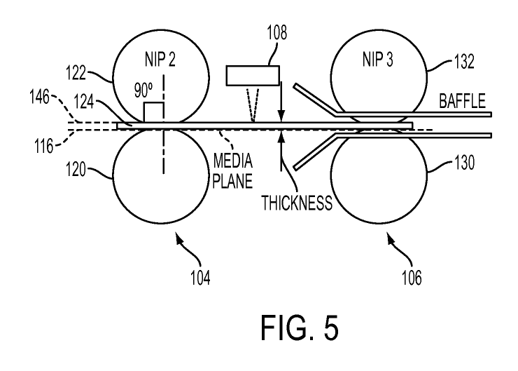

The apparatus can also include a decurler 136 positioned within the media path 116. The processor 118 automatically alters settings of the decurler 136 based on the amount of curl the media sheet 124 contains. Further, the apparatus can contain a marking engine 138 positioned within the media path 116. Again, the processor 118 automatically alters setting of the marking engine 138 based on the amount of curl the media sheet 124 contains. The marking engine 138 can comprise any type of marking engine 138, such as an electro-photographic printing engine, an inkjet printing engine, an ultra-violet curable printing engine, etc. Note that some of the elements from FIG. 1 are not included in FIGS. 2 and 5 to avoid clutter in the drawings; however, such elements could be included in the structures shown in FIGS. 2 and 5 and are intended to be understood as being included in such structures. Further, while the decurler 136 and the marking engine 138 are shown in certain positions relative to the sensor 108 and nips 102, 104, 106, those ordinarily skilled in the art would understand that the relative positions of such items could be different and that more than one of each item could be included in embodiments herein.

Referring to FIG. 2, the media sheet 124 first enters nip 1 (102) then is driven to nip 2 (104) which is overdriven slightly faster than nip one 102. Over-driving the media sheet 124 in combination with nip 2 (104) being a set of two like rolls (both soft or both hard) helps to eliminate any bias of nip 2 (104) from driving the media sheet 124 up or down. Restated, nip two (104) drives the media sheet 124 out of its nip in plane with the media plane 116 formed by nips one and two. The media sheet 124 is held very close to 90° from the centerline 116 of nip 2 (104) so that its entry angle does not influence its exit angle. As shown in FIG. 2, the media sheet 124 on exiting nip 2 (104) is free to curl up, curl down or exit straight out of the nip to be measured by the displacement sensor 108. With embodiments herein, the media sheet 124 curl (fly height) is read very close to nip two 104 (e.g., 10 mm, 20 mm, 30 mm, etc., from the second nip 104).

The processor 118 (that is operatively connected to the sensor 108) automatically calculates the amount of curl the media sheet 124 contains based on the difference between a predetermined position (which could be the centerline of the media path 116) and the position of the leading edge of the media sheet 124 (relative to the sensor 108) as the leading edge of the media sheet 124 passes between the second nip 104 and the third nip 130. The position of the leading edge of the media 124 is shown as item 144 in FIG. 2. Therefore, the processor 118 calculates the curl distance as the difference between 116 and 144. From this distance the curl radius and sheet curl can be determined using lookup charts or methodologies, as discussed below.

By reading the media height a short distance from the second nip 104, the effects of the media's beam strength are mitigated because a very short stub of media sheet 124 is less likely to bend under its own weight than if it is a longer unsupported piece.

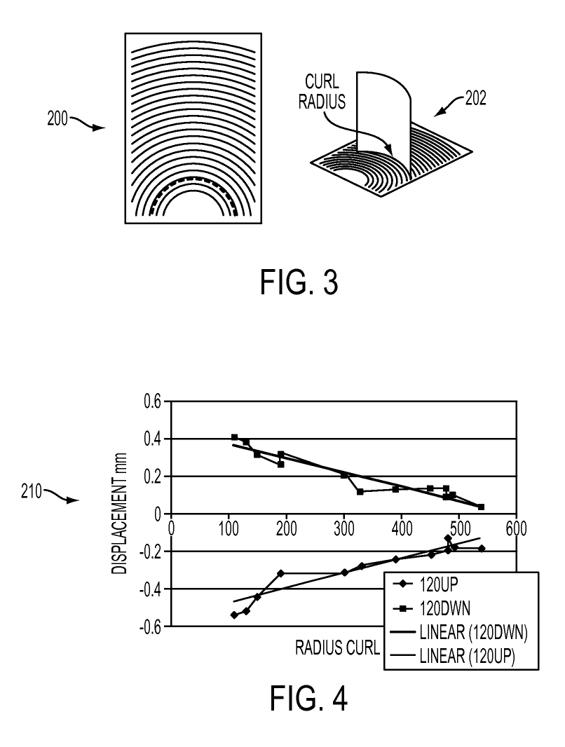

The systems and methods disclosed herein determine overall or uniform curl on media as can be seen in the hanging radius curl method of determining curl, see FIG. 3. With this method, media is fit to the circumference or curvature of a circle (item 202) with its curl being defined as the radius or 1/radius using a predetermined lookup chart 200. Because the curl is even, the angle formed by any line tangent to the media sheet 124 will be the same for any point about the curvature of the media sheet 124. With this in mind, measuring the height of the media sheet 124 just as the media sheet 124 exits nip 2 (104) should be the same angle that would be seen further into the sheet if gravity were not a factor. So by measuring the height of the media sheet 124 immediately exiting nip 2 (104) the hanging radius curl can be determined.

There are other advantages of measuring the media sheet 124 close to the second nip 104. For example, by doing so the media sheet 124 will have less distance to curl up or down and its displacement height will be less, so the displacement sensor 108 needed can be of a smaller displacement range (which lowers cost). Also, by measuring the media sheet 124 close to the second nip 104, the media cannot curl up or down excessively thereby getting out of control and possibly folding over on itself when it enters any downstream baffles 114. Note that baffles 114 have a wide opening that narrows as the baffle reaches the third nip 106 to allow curled sheets to be properly fed to the third nip 106.

FIG. 4 is a chart showing curl data taken from a laser displacement sensor 108. In the example in FIG. 4, a coated 120 gsm media was fed through a nip of two solid 20 mm diameter rolls and readings were taken 18 mm from the center of the second nip 104. The data show is in pairs, that is, each sheet of media sheet 124 was fed twice, once in the up and once in the down curl position. The test shows that as the media sheet 124 curl decreases so does the tip fly height. Of note, is the fact that tip fly height and media sheet caliper thickness are very close together for less curled media sheet in the 400 mm radius curl area. The caliper thickness of the media sheet 124 was 0.10 mm.

Another aspect of embodiments herein is the ability to measure the media's thickness. The processor 118 can automatically calculate the thickness of the media sheet 124 based on the difference between the predetermined position 116 and the position of the media sheet 146 (relative to the sensor 108) as the media sheet 124 passes between the second nip 104 and the third nip 130. Therefore, as shown in FIG. 5, if the “predetermined position” is established as the portion of of the media path 116 where the bottom of the media sheet lies, the media sheet thickness would be the difference between items 116 and 146. If the “predetermined position” is the centerline of the media path 116, the media sheet thickness would be twice the difference between items 116 and 146.

The media thickness measurement is accomplished with the same displacement sensor 108, but with the media sheet 124 stretched tight into nip 3 (106) as opposed to allowing the leading edge of the media to curl up or down, as was shown in FIG. 2. Again the downstream nip 106 is slightly over-driven to take up any slack and ensure that the media sheet 124 is flat between the second nip 104 and the third nip 106.

For the accuracy of displacement sensor 108, a calibration procedure can occur, whereby a known thickness media sheet 124 is run and measured for media thickness by the displacement sensor 108 as in FIG. 5. The resulting values would then be compared to known values and the sensor 108 would be calibrated to the known value. This process establishes the “predetermined position” that is mentioned above.

Within the nips 102, 104, 106, the bottom three rollers 110, 120, 130 are fixed (these rollers can rotate, but their axles do not move relative to the media path 116). Therefore, the top rollers 112, 122, 132, can rotate and move up and down relative to the media path 116 to accommodate different media thicknesses. This provides an unmovable reference plane (e.g., 116) with respect to media sheet 124 to allow the media thickness and curl measurements to be consistent. Therefore, the opposing rollers within the first nip 102, the second nip 104, and the third nip 130 each comprise a fixed-position roller and a floating roller. The floating roller is positioned to contact a first side (the top side) of the media sheet 124 and the sensor 108 is also positioned to sense the first side of the media sheet 124. The opposing rollers 120, 122 of the second nip 104 rotate faster than the opposing rollers 110, 112 of the first nip 102, and the opposing rollers 130, 132 of the third nip 130 rotate faster than the opposing rollers of the second nip 104 to keep the media sheet 124 taunt during the curl and thickness measurements.

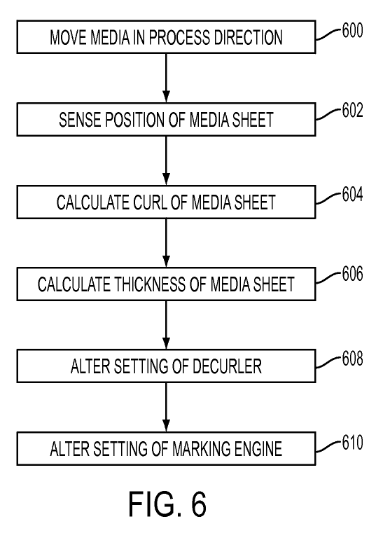

Method embodiments are also included herein as shown, for example, in FIG. 6. In such embodiments, as shown in item 600, the method moves the media sheet 124 in the processing direction of the media path 116 from the first nip 102 to the second nip 104 and moves the media sheet 124 in the processing direction of the media path 116 from the second nip 104 to the third nip 130. In item 602, the method senses, using the sensor 108 positioned between the second nip 104 and the third nip 130, the position of the media sheet 124 relative to the sensor 108. In item 604, the method automatically calculates the amount of curl the media sheet 124 contains based on the difference between the predetermined position and the position of the leading edge of the media sheet 124 (relative to the sensor 108) as the leading edge of the media sheet 124 passes between the second nip 104 and the third nip 130, using the processor 118. Further, the method automatically calculates the thickness of the media sheet 124 based on the difference between the predetermined position and the position of the media sheet 124 (relative to the sensor 108) as the media sheet 124 passes between the second nip 104 and the third nip 130, using the processor 118 in item 606.

In item 608, the method can also automatically alter the settings of the decurler 136 positioned within the media path 116 based on the amount of the curl the media sheet 124 contains using the processor 118. Also, the method can automatically alter settings of the marking engine 138 positioned within the media path 116 based on the amount of curl the media sheet 124 contains and the thickness of the media sheet 124 using the processor 118 in item 610.

Thus, as show above, the embodiments herein use a displacement sensor to measure the amount of curl of media exiting from a controlled nip and can use the same displacement sensor to measure the media sheet thickness in a controlled nip for more accurate results. The embodiments herein use actual measured properties of media to determine curl which is dynamic and more accurate that projections based on environmental conditions and user input. Similarly, the embodiments herein use actual measured thickness to determine media weight which provides greater accuracy and less fallibility when compared to user input.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. An apparatus comprising:
a media path that transports a media sheet;
a first nip comprising opposing rollers that move said media sheet in a processing direction along said media path;
a second nip comprising opposing rollers, said second nip being positioned within said media path to receive said media sheet from said first nip;
a third nip comprising opposing rollers, said third nip being positioned within said media path to receive said media sheet from said second nip;
a sensor positioned between said second nip and said third nip sensing a position of said media sheet relative to said sensor; and
a processor operatively connected to said sensor, said processor automatically calculating an amount of curl said media sheet contains based on a difference between a predetermined position and a position of a leading edge of said media sheet relative to said sensor as said leading edge of said media sheet passes between said second nip and said third nip.

2. The apparatus according to claim 1, said opposing rollers within said first nip, said second nip, and said third nip each comprising a fixed-position roller and a floating roller, said floating roller being positioned to contact a first side of said media sheet and said sensor being positioned to sense said first side of said media sheet.

3. The apparatus according to claim 1, said opposing rollers of said second nip rotating faster than said opposing rollers of said first nip, and said opposing rollers of said third nip rotating faster than said opposing rollers of said second nip.

4. The apparatus according to claim 1, further comprising a decurler positioned within said media path, said processor automatically altering settings of said decurler based on said amount of curl said media sheet contains.

5. The apparatus according to claim 1, further comprising a marking engine positioned within said media path, said processor automatically altering setting of said marking engine based on said amount of curl said media sheet contains, said marking engine comprising one of an electro-photographic printing engine, an inkjet printing engine, and an ultra-violet curable printing engine.

6. An apparatus comprising:
a media path that transports a media sheet;
a first nip comprising opposing rollers that move said media sheet in a processing direction along said media path;
a second nip comprising opposing rollers, said second nip being positioned within said media path to receive said media sheet from said first nip;
a third nip comprising opposing rollers, said third nip being positioned within said media path to receive said media sheet from said second nip;
a sensor positioned between said second nip and said third nip sensing a position of said media sheet relative to said sensor; and
a processor operatively connected to said sensor, said processor automatically calculating an amount of curl said media sheet contains based on a difference between a predetermined position and a position of a leading edge of said media sheet relative to said sensor as said leading edge of said media sheet passes between said second nip and said third nip,
said processor automatically calculating a thickness of said media sheet based on a difference between said predetermined position and a position of said media sheet relative to said sensor as said media sheet passes between said second nip and said third nip.

7. The apparatus according to claim 6, said opposing rollers within said first nip, said second nip, and said third nip each comprising a fixed-position roller and a floating roller, said floating roller being positioned to contact a first side of said media sheet and said sensor being positioned to sense said first side of said media sheet.

8. The apparatus according to claim 6, said opposing rollers of said second nip rotating faster than said opposing rollers of said first nip, and said opposing rollers of said third nip rotating faster than said opposing rollers of said second nip.

9. The apparatus according to claim 6, further comprising a decurler positioned within said media path, said processor automatically altering settings of said decurler based on said amount of curl said media sheet contains.

10. The apparatus according to claim 6, further comprising a marking engine positioned within said media path, said processor automatically altering setting of said marking engine based on said amount of curl said media sheet contains and said thickness of said media sheet, said marking engine comprising one of an electro-photographic printing engine, an inkjet printing engine, and an ultra-violet curable printing engine.

11. A method comprising:
moving a media sheet in a processing direction of a media path from a first nip comprising opposing rollers to a second nip comprising opposing rollers;
moving said media sheet in said processing direction of said media path from said second nip to a third nip comprising opposing rollers;
sensing, using a sensor positioned between said second nip and said third nip, a position of said media sheet relative to said sensor; and
automatically calculating an amount of curl said media sheet contains based on a difference between a predetermined position and a position of a leading edge of said media sheet relative to said sensor as said leading edge of said media sheet passes between said second nip and said third nip, using a processor.

12. The method according to claim 11, said opposing rollers within said first nip, said second nip, and said third nip each comprising a fixed-position roller and a floating roller, said floating roller being positioned to contact a first side of said media sheet and said sensor being positioned to sense said first side of said media sheet.

13. The method according to claim 11, further comprising rotating said opposing rollers of said second nip faster than said opposing rollers of said first nip, and rotating said opposing rollers of said third nip faster than said opposing rollers of said second nip.

14. The method according to claim 11, further comprising automatically altering settings of a decurler positioned within said media path based on said amount of curl said media sheet contains using said processor.

15. The method according to claim 11, further comprising automatically altering setting of a marking engine positioned within said media path based on said amount of curl said media sheet contains using said processor, said marking engine comprising one of an electro-photographic printing engine, an inkjet printing engine, and an ultra-violet curable printing engine.

16. A method comprising:
moving a media sheet in a processing direction of a media path from a first nip comprising opposing rollers to a second nip comprising opposing rollers;
moving said media sheet in said processing direction of said media path from said second nip to a third nip comprising opposing rollers;
sensing, using a sensor positioned between said second nip and said third nip, a position of said media sheet relative to said sensor;
automatically calculating an amount of curl said media sheet contains based on a difference between a predetermined position and a position of a leading edge of said media sheet relative to said sensor as said leading edge of said media sheet passes between said second nip and said third nip, using a processor; and
automatically calculating a thickness of said media sheet based on a difference between said predetermined position and a position of said media sheet relative to said sensor as said media sheet passes between said second nip and said third nip, using said processor.

17. The method according to claim 16, said opposing rollers within said first nip, said second nip, and said third nip each comprising a fixed-position roller and a floating roller, said floating roller being positioned to contact a first side of said media sheet and said sensor being positioned to sense said first side of said media sheet.

18. The method according to claim 16, further comprising rotating said opposing rollers of said second nip faster than said opposing rollers of said first nip, and rotating said opposing rollers of said third nip faster than said opposing rollers of said second nip.

19. The method according to claim 16, further comprising automatically altering settings of a decurler positioned within said media path based on said amount of said curl said media sheet contains using said processor.

20. The method according to claim 16, further comprising automatically altering setting of a marking engine positioned within said media path based on said amount of curl said media sheet contains and said thickness of said media sheet using said processor, said marking engine comprising one of an electro-photographic printing engine, an inkjet printing engine, and an ultra-violet curable printing engine.
